(19) United States
(12) Patent Application Publication
(10) Pub. No.: US 2003/0178272 A1
(43) Pub. Date: Sep. 25, 2003

(54) Vehicle brake hydraulic pressure generator

(75) Inventor: Akihito Kusano, Kariya (JP)

Correspondence Address: BURNS, DOANE, SWECKER & MATHIS, L.L.P., P.O. Box 1404, Alexandria, VA, 22313-1404, US

(73) Assignee: ADVICS CO., LTD.

(21) Appl. No.: 10/374,062

(22) Filed: Feb. 27, 2003

(30) Foreign Application Priority Data
Feb. 28, 2002 (JP) 2002-53342

(51) Int. Cl. B60T 11/00

(52) U.S. Cl. 188/358; 188/355

(57) ABSTRACT

With a brake hydraulic pressure generator in which the brake operating force is applied to a pressure adjusting valve through a stroke simulator and hydraulic pressure supplied from the hydraulic pressure source is adjusted to a value corresponding to the brake operating force by the pressure adjusting valve, at the relaxing of the brake operating force, the return stroke until the output hydraulic pressure of the pressure adjusting valve begins to drop is large. Thus a delay in the decrease of an output hydraulic pressure occurs. This worsens brake feeling. To solve this problem, the sliding resistance of the simulator piston is set to be greater than that of the input piston so that at the relaxing of the brake operating force, the input piston moves relative to the pressure adjusting valve before the simulator piston moves relative to the input piston. This quickens response of an output hydraulic pressure drop relative to the relaxing of the brake operating force.

### BACKGROUND OF THE INVENTION

This invention relates to a vehicle brake hydraulic pressure generator which adjusts the hydraulic pressure supplied from a hydraulic pressure source including a power-driven pump to a value corresponding to a brake operating force by means of a pressure adjusting valve and outputs it.

A brake hydraulic pressure generator of this type is disclosed in JP patent publication 61-37140.

With the device of this publication, the brake operating force from the brake pedal is applied to an operating rod inserted in a booster piston, and transmitted to an input rod in the booster piston through a stroke limiting spring. The input rod closes an outlet valve and opens an inlet valve to adjust the hydraulic pressure supplied by a pump into a pressure accumulating chamber upstream of the booster piston and output it.

The output hydraulic pressure of the pressure adjusting valve is supplied not only to a first hydraulic line as the brake hydraulic pressure, but also to the master cylinder. By the hydraulic pressure, the master cylinder is activated, so that brake hydraulic pressure is generated in the second hydraulic line, which is independent of the first hydraulic line. The operating rod in this publication corresponds to the simulator piston of the present application, the stroke limiting spring to the elastic member, the pressure release chamber to the simulator chamber, and the supplementing chamber to the atmospheric reservoir.

With the brake hydraulic pressure generator using a booster of this publication, in order to reduce the brake hydraulic pressure during relaxing of the brake operating force, in addition to a stroke for opening the pressure-reducing port (outlet valve) of the pressure adjusting valve, a stroke for returning the stroke limiting spring to a point corresponding to the output hydraulic pressure of the pressure adjusting valve which is being reduced, is needed. Therefore, the hydraulic pressure drop in response to the relaxing of the brake operating force is retarded, so that bad brake feeling will be felt by the driver.

With the device of the abovesaid publication, which is provided with a master cylinder operated under the output pressure of the pressure adjusting valve, it is necessary to reduce the output pressure of the pressure adjusting valve during the relaxing of the brake operating force, by an amount corresponding to the slide resistance of the master cylinder piston. Therefore, the stroke of the stroke limiting spring increases accordingly. This further impairs the brake feeling at the relaxing of the brake operating force.

An object of this invention is to improve brake feelings during relaxing of the brake operating force by improving the responsiveness of the output hydraulic pressure (i.e. braking force) to the relaxing of the brake operating force.

### SUMMARY OF THE INVENTION

According to this invention, there is provided a vehicle brake hydraulic pressure generating device comprising a hydraulic pressure source for generating a predetermined hydraulic pressure, a stroke simulator comprising a simulator piston operatively coupled with a brake operating member and an elastic member for imparting a stroke corresponding to the brake operating force to the simulator piston, an input piston having the simulator piston therein for receiving the brake operating force from the simulator piston through the elastic member, and a pressure adjusting valve which activates according to the displacement of the input piston to adjust the hydraulic pressure supplied from the hydraulic pressure source to a value corresponding to the brake operating force, characterized in that the sliding resistance of the simulator piston is set to be greater than that of the input piston.

A method of creating a difference in the sliding resistance between the simulator piston and the input piston is not limited but a method is simple in which a first sealing member for sealing the outer periphery of the simulator piston is given a different hardness or interference from that of a second sealing member for sealing the outer periphery of the input piston so that the sliding resistance of the simulator piston is greater than that of the input piston.

When the brake operating force is relaxed, since the sliding resistance of the simulator piston is greater than that of the input piston, the input piston begins to move relative to the pressure adjusting valve before the simulator piston begins to move relative to the input piston. Thus it is possible to open the pressure reducing port of the pressure adjusting valve with the return stroke of the input piston only (heretofore, the moving amount of the simulator piston relative to the input piston has been added thereto). Thus the response of an output hydraulic pressure drop to the relaxing of the brake operating force quickens. This improves the brake feeling.

### BRIEF DESCRIPTION OF THE DRAWINGS

Other features and objects of the present invention will become apparent from the following description made with reference to the accompanying drawings, in which:

FIG. 1 is a sectional view showing an embodiment of the brake hydraulic pressure generating device; and

FIG. 2 is a graph showing an ideal relation between the simulator piston stroke and the output hydraulic pressure of the pressure adjusting valve.

### DETAILED DESCRIPTION OF THE PREFERRED EMBODIMENT

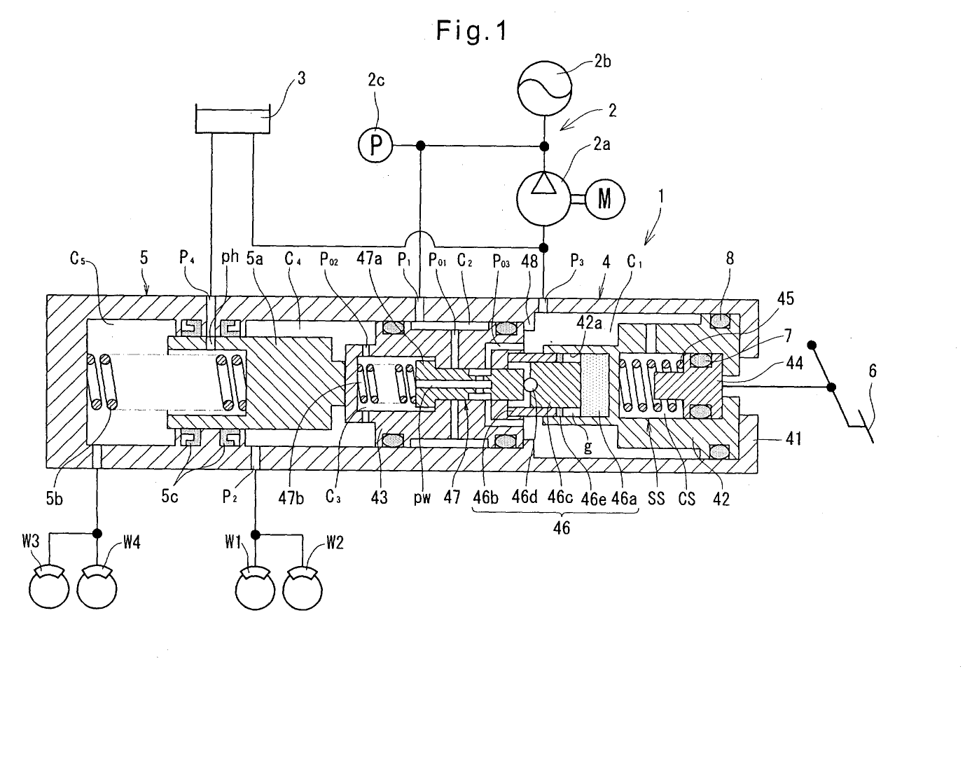

Hereinbelow, the embodiment of this invention will be described with reference to FIG. 1.

The brake hydraulic pressure generating device of FIG. 1 comprises a hydraulic pressure source 2, an atmospheric reservoir 3, and a pressure adjusting device 4 with a master cylinder 5 integrally formed.

The hydraulic pressure source 2 includes a power pump 2a, a pressure accumulator 2b and a pressure sensor 2c. When the hydraulic pressure detected by the pressure sensor 2c reaches a preset lower limit, a command is given from a control device (not shown) that receives signals from the pressure sensor 2c, to activate the pump 2a. When the detected hydraulic pressure reaches a preset upper limit, the pump 2a will stop. Thus, in a normal state, a hydraulic pressure within a predetermined range is always stored in the hydraulic pressure source 2, and the hydraulic pressure is supplied to the pressure adjusting device 4 when the brake is operated.

The atmospheric reservoir 3 is connected to the intake side of the pump 2a, a fluid chamber C₁ in the pressure adjusting device 4 and the master cylinder 5.

The pressure adjusting device 4 includes a housing 41, an input piston 42 mounted in the housing 41 with its tip protruding into the fluid chamber C₁, an auxiliary piston 43 arranged in front of the input piston 42, a simulator piston 44 provided in the input piston 42 with its front portion in a simulator chamber CS, an elastic member 45 (a coil spring in the figure but a rubber or an air spring may be used singly or in combination) for imparting a stroke corresponding to the brake operating force applied from a brake operating member (a brake pedal 6 in the figure) to the simulator piston 44, a distributor 46 for splitting the brake operating force transmitted from the simulator piston 44 to the input piston 42 through the elastic member 45 and transmitting it to the below-described pressure adjusting valve and an auxiliary piston 43, and a pressure adjusting valve 47 for adjusting the brake hydraulic pressure supplied from the hydraulic pressure source 2 to a value corresponding to the brake operating force. The simulator piston 44, elastic member 45 and simulator chamber CS, which communicates with the fluid chamber C₁ through a hole formed through the input piston 42, form a stroke simulator.

The distributor 46 includes a rubber member 46a provided in an annular recess 42a formed in the tip of the input piston 42, a tubular member 46b having its one end abutting the auxiliary piston 43 and the other end inserted in the annular recess 42a, and a transmitting member 46c and a steel ball 46d mounted in the tubular member 46b and disposed between the rubber member 46a and the pressure adjusting valve 47. A gap g is provided between the rubber member 46a and an annular resin plate 46e mounted at the end of the tubular member 46b for protecting the rubber member 46a.

By providing the distributor 46, in the initial stage of brake operation, the brake operating force is transmitted only to the pressure adjusting valve 47 through the rubber member 46a, the transmitting member 46c and the steel ball 46d. When the brake operating force exceeds a certain value, the rubber member 46a, which has been resiliently deformed to get into the gap g, comes into contact with the annular plate 46e. Thereafter, part of the brake operating force is distributed through the tubular member 46b to the auxiliary piston 43 as well.

Thus, this function makes it possible to impart jumping property, which makes sharp the initial buildup of the brake hydraulic pressure adjusted by the pressure adjusting valve 47, to the brake hydraulic pressure generator. Further, if the inner diameter of the tubular member 46b and the outer diameter of the transmitting member 46c change, the distribution ratio of the brake operating forces transmitted to the pressure adjusting valve 47 and the auxiliary piston 43 changes. Further, with changes in the lengths of these members, the distribution start timing changes. Thus, by replacing the tubular member 46b and the transmitting member 46c with ones having different sizes, it is possible to change the relation between the brake operating force and the output hydraulic pressure of the pressure adjusting valve.

In this regard, the provision of the distributor 46 is preferable. But it is possible to omit it and directly transmit the force from the input piston 42 to the pressure adjusting valve 47.

The pressure adjusting valve 47 shown is of a type in which pressure increase, decrease and hold are changed over by a spool 47a.

The auxiliary piston 43 has an input port P_{0 1}, output port P_{0 2} and a pressure reducing port P_{0 3}. Changeover of connection between these ports and the adjustment of the degree of opening of the valve portions are carried out by displacing the spool 47a.

The input port P_{0 1} normally communicates with the hydraulic pressure source 2 through an annular input chamber C₂ provided around the auxiliary piston 43, and an input port P₁ provided in the housing 41. The pressure reducing port P_{0 3} normally communicates with the atmospheric reservoir 3 through a fluid chamber C₁ and a drain port P₃ provided in the housing 41. The output port P_{0 2} is disposed between a fluid chamber C₃ in the auxiliary piston 43 and a fluid chamber C₄ in which the front portion of the auxiliary piston 43 is disposed, and an internal passage pw provided in the spool 47a communicates with an output port P₂ provided in the housing 41.

In the pressure adjusting valve 47 thus structured, when the spool 47a is pushed back by a return spring 47b to the illustrated original position in FIG. 1, the internal passage pw in the spool 47a is connected to the pressure reducing port P_{0 3} so as to be in the pressure-reduced state. When the spool 47a is pushed in leftwardly in FIG. 1 from this position, the internal passage pw will be separated from both the pressure reducing port P_{0 3} and the input port P_{0 1} so as to be in the output holding state. When the spool 47a is further pushed in from this position, the internal passage pw is connected to the input port P_{0 1}, so that the hydraulic pressure supplied from the hydraulic pressure source 2 flows into the fluid chamber C₄. Thus, the wheel cylinders W1 and W2 in the right-hand line in FIG. 1 (hereinafter called a first hydraulic pressure line) will be in a pressure-increased state.

The spool 47a moves to a point where the sum of the thrust by the hydraulic pressure introduced into the fluid chamber C₃ and the force of the return spring 47b, balances with the brake operating force applied through the input piston 42. Thus, adjustment is made of the degree of opening of a valve portion formed between the input port P_{0 1} and the shoulder of the spool 47a when the internal passage pw is connected to the input port P_{0 1}, and the degree of opening of a valve portion formed between the pressure reducing port P_{0 3} and the shoulder of the spool 47a when the internal passage pw is connected to the pressure reducing port P_{0 3}, so that the brake hydraulic pressure outputted from the output port P_{0 2} will be adjusted to a value corresponding to the brake operating force.

When hydraulic pressure is introduced into the fluid chamber C₄, the auxiliary piston 43 is pressed against a stopper 48 in the housing 41 by the hydraulic pressure. Thus, while the hydraulic pressure source 2 and the first hydraulic pressure line are normally operating, the auxiliary piston 43 will be held in the illustrated position.

The master cylinder 5 comprises a master piston 5a having its front portion disposed in a master chamber C₅ and its rear portion in a fluid chamber C₄, a return spring 5b for the master piston, and two sets of cup seals 5c liquid-tightly sealing the outer periphery of the master piston 5a.

When the output hydraulic pressure is introduced into the fluid chamber C₄ through the pressure adjusting valve 47, the master piston 5a moves toward the master chamber C₅ under the pressure. In the initial stage of this movement, a hole ph formed in the master piston 5a is separated from a port P₄ communicating with the atmospheric reservoir 3. Thereafter, a fluid pressure substantially equal to the pressure in the fluid chamber C₄ is produced in the master chamber C₅, and is supplied to the wheel cylinders W3 and W4 in the second hydraulic line.

The-master cylinder 5 is provided as fail-safe measures if the hydraulic pressure source 2 or the first hydraulic line should fail. That is, if hydraulic pressure should not be produced in the fluid chamber C₄ due to a failure of the hydraulic pressure source 2, the auxiliary piston 43 is moved by the brake operating force applied through the input piston 42 and the brake operating force is directly transmitted to the master piston 5a through the auxiliary piston 43. Thus, hydraulic pressure proportional to the brake operating force is outputted from the master cylinder 5 to the wheel cylinders W3 and W4 in the second hydraulic line. This avoids so-called no braking in which brakes will not work.

With the brake hydraulic pressure generator of FIG. 1, on the outer periphery of the simulator piston 44, a first rubber seal member 7 is provided to liquid-tightly seal between the input piston 42 and the outer periphery of the simulator piston 44, and on the outer periphery of the input piston 42, a second rubber seal member 8 is provided to liquid-tightly seal between the input piston 42 and the housing 41. Either by setting the hardness of the first seal member 7 higher than that of the second seal member 8, or by setting the interference of the first seal member 7 greater than that of the second seal member 8, the slide resistance of the simulator piston 44 is set to be greater than that of the input piston 42.

Thus, during the relaxing of the brake operating force, before the simulator piston 44 moves relative to the input piston 42, the input piston 42 moves relative to the pressure adjusting valve 47. Thus, start of the pressure reduction occurs earlier, so that the response of the output hydraulic pressure drop to the relaxing of the brake operating force improves. This eliminates uncomfortable feeling in brake operation.

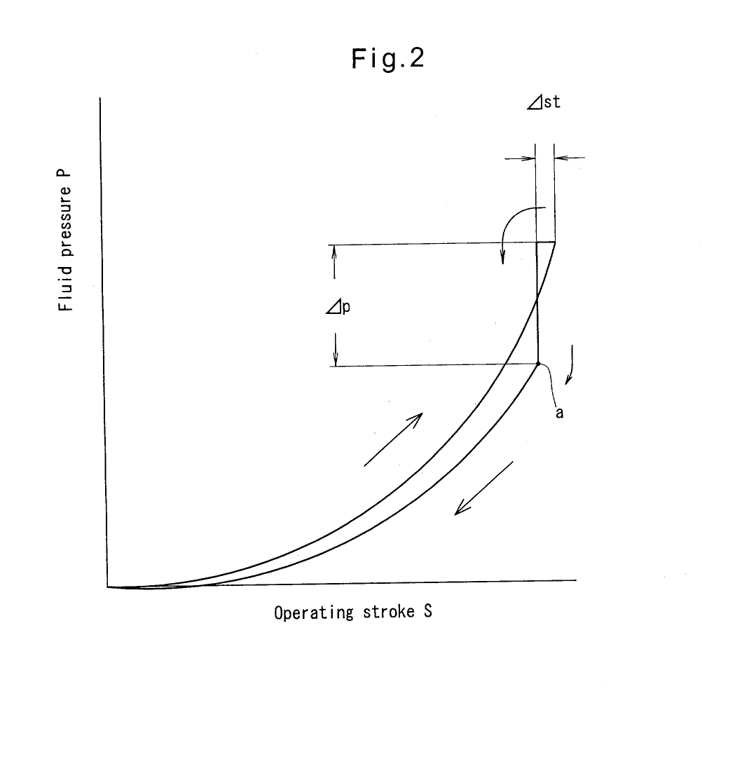

By properly setting the sliding resistances of the input piston 42 and the simulator piston 44, as shown in FIG. 2, it is possible to achieve such properties that the output hydraulic pressure of the pressure adjusting valve 47 relative to the simulator piston stroke while the brake operating force is increasing (during pressure rise) is higher than the output hydraulic pressure of the pressure adjusting valve 47 relative to the simulator piston stroke while the brake operating force is decreasing.

If the properties as shown in FIG. 2 are imparted, no relative movement will occur between the input piston 42 and the simulator piston 44 until the stroke of the simulator piston returns by Δ st, and the pressure-reducing port P_{0 3} of the pressure adjusting valve 47 opens only with a stroke of Δ st. Thus, movement of the simulator piston 44 relative to the input piston 42 begins only at point a in FIG. 2.

While the relation between the operating stroke of the simulator piston 44 and the output hydraulic pressure of the pressure adjusting valve 47 shown in FIG. 2 is ideal, it is not limited thereto. If the sliding resistance of the simulator piston 44 is set to be greater than that of the input piston 42, the output hydraulic pressure of the pressure adjusting valve 47 drops when the input piston 42 returns by a stroke of Δ st, so that the effect of reduced uncomfortable feeling is achieved due to improvement in the response of an output hydraulic pressure drop.

While the illustrated device is provided with a master cylinder, this invention is also applicable to a device having no master cylinder.

As described above, according to this invention, since the sliding resistance of the simulator piston is set to be larger than that of the input piston so that during reduction of the brake operating force, the pressure reducing port of the pressure adjusting valve is opened at a position where the simulator piston has returned by a small distance, it is possible to begin to reduce the output hydraulic pressure earlier than before by improving the response to the relaxing of the brake operating force. Thus the brake feeling during relaxing of the brake operating force improves.

What is claimed is:

1. A vehicle brake hydraulic pressure generating device comprising a hydraulic pressure source for generating a predetermined hydraulic pressure, a stroke simulator comprising a simulator piston operatively coupled with a brake operating member and an elastic member for imparting a stroke corresponding to the brake operating force to said simulator piston, an input piston having said simulator piston therein for receiving the brake operating force from said simulator piston through said elastic member, and a pressure adjusting valve which activates according to the displacement of said input piston to adjust the hydraulic pressure supplied from said hydraulic pressure source to a value corresponding to the brake operating force, characterized in that the sliding resistance of said simulator piston is set to be greater than that of said input piston.

2. A vehicle brake hydraulic pressure generating device as claimed in claim 1 wherein a first sealing member for seating the outer periphery of said simulator piston has a different hardness or interference from that of a second sealing member for sealing the outer periphery of said input piston so that the sliding resistance of said simulator piston is set to be greater than that of the input piston.
